(19) United States
(12) Patent Application Publication
(10) Pub. No.: US 2010/0205990 A1
(43) Pub. Date: Aug. 19, 2010

(54) INTEGRATED PORTABLE UNIT FOR PROVIDING ELECTRICITY, AIR-CONDITIONING, AND HEATING

(76) Inventors: Irvin L. French, North Vernon, IN (US); Samuel D. Markel, Seymour, IN (US)

Correspondence Address: Woodard, Emhardt, Moriarty, McNett & Henry LLP, 111 Monument Circle, Suite 3700, Indianapolis, IN, 46204-5137, US

(21) Appl. No.: 12/707,931

(22) Filed: Feb. 18, 2010

Related U.S. Application Data
(60) Provisional application No. 61/153,420, filed on Feb. 18, 2009.

(51) Int. Cl. B60H 1/00; B61D 27/00

(52) U.S. Cl. 62/239; 165/43; 454/69; 237/28

(57) ABSTRACT

Disclosed is an integrated unit packaged on a vehicle for providing electricity, air-conditioning and heating to a space remote from the vehicle. The unit includes an electric generator system, a ventilation system, a refrigeration cycle system, each of which is powered by the electric generator system, a heater that is also powered by the electric generator system and electrical outlets that are also powered by the electric generator.

### CROSS REFERENCES TO RELATED APPLICATIONS

The present application claims the benefit of U.S. Provisional Application No. 61/153,420, filed Feb. 18, 2009, which is hereby incorporated by reference in its entirety.

### BACKGROUND OF THE INVENTION

This disclosure is related to an integrated portable unit for providing electricity, air-conditioning and heating.

### BRIEF SUMMARY

Disclosed is an integrated unit arranged and/or packaged on a vehicle for providing electricity, air-conditioning and heating to a space or location which is remote from the vehicle. The unit includes an electric generator system, a ventilation system, a refrigeration cycle system powered by the electric generator system, a heater that is also powered by the electric generator system and electrical outlets that are also powered by the electric generator.

### BRIEF DESCRIPTION OF THE SEVERAL VIEWS OF THE DRAWINGS

FIG. 1 is a system diagram of one embodiment of an integrated portable unit for providing electricity, air-conditioning and heating.

FIG. 2 is a left side elevational view of a trailer embodying one version of an integrated portable unit for providing electricity, air-conditioning and heating.

FIG. 3 is a right side elevational view of the trailer of FIG. 2.

FIG. 4 is a front elevational view of the trailer of FIG. 2.

FIG. 5 is a rear elevational view of the trailer of FIG. 2.

FIG. 6 is a rear elevational view of the trailer of FIG. 2, with some components removed as compared to the trailer of FIG. 5.

FIG. 7 is a top plan view of the trailer of FIG. 2.

FIG. 8 is a partial, perspective view of the trailer of FIG. 2, providing HVAC to a tent.

FIG. 9 is a rear elevational view of a HVAC unit.

FIG. 10 is a rear elevational view of the FIG. 9 HVAC unit with access doors removed.

FIG. 11 is a right side elevational view of the FIG. 10 HVAC unit.

FIG. 12 is a front elevational view of the FIG. 10 HVAC unit.

FIG. 13 is a left side elevational view of the FIG. 10 HVAC unit.

FIG. 14 is a schematic illustration of one configuration of an automatic control touch screen.

FIG. 15 is a schematic illustration of a manual control touch screen.

### DETAILED DESCRIPTION

For the purpose of promoting an understanding of the disclosure, reference will now be made to certain embodiments thereof and specific language will be used to describe the same. It will nevertheless be understood that no limitation of the scope of this disclosure is thereby intended, such alterations, further modifications and further applications of the principles described herein being contemplated as would normally occur to one skilled in the art to which the disclosure relates. In several figures, where there are the same or similar elements, those elements are designated with similar reference numerals.

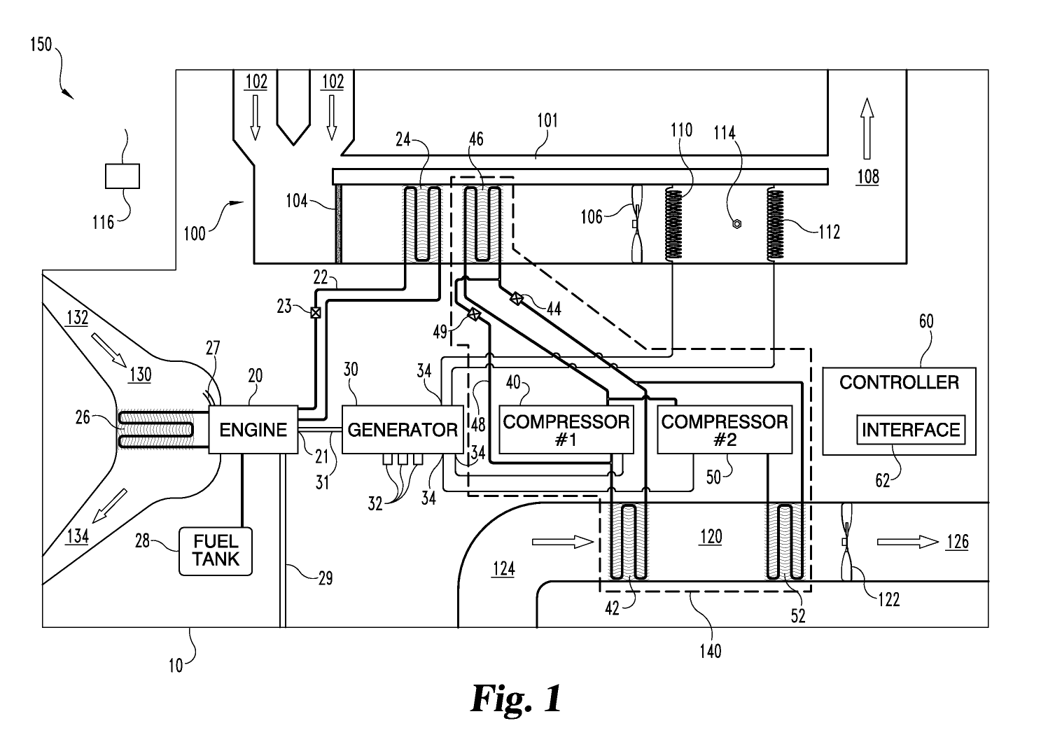

Referring now to FIG. 1, a diagram of an integrated portable unit for providing electricity, air-conditioning and heating is illustrated as system 150. System 150 generally comprises engine 20, generator 30, compressors 40 and 50, controller 60, HVAC duct 100, AC exhaust duct 120 and engine compartment 130 all positioned in vehicle 10.

HVAC duct 100 includes bypass 101, inlets 102, filter 104, radiator 24, evaporator coil 46, blower 106, heaters 110 and 112, thermocouple 114, and outlet 108. Bypass 101 circulates air from the vicinity of outlet 108 back to the vicinity of inlets 102. In the illustrated embodiment, approximately 20% of the airflow is redirected from the vicinity of outlet 108 back to the vicinity of inlets 102 by bypass 101. In another embodiment, bypass 101 redirects approximately 10% of the airflow from the vicinity of outlet 108 back to the vicinity of inlets 102. In yet another embodiment, bypass 101 redirects between approximately 0-20% of the airflow from the vicinity of outlet 108 back to the vicinity of inlets 102. Thermocouple 114 provides temperature feedback of the operation of heaters 110 and 112 and may be used as an over-temperature sensor.

Radiator 24 is coupled to engine 20 via heat transfer fluid line 22 that transfers a heat transfer fluid such as oil, water or glycol between engine 20 and radiator 24. In the illustrated embodiment, the heat transfer fluid is oil that also serves to lubricate engine 20.

System 150 also includes wireless temperature and humidity sensor 116 remotely located in the space being heated and/or cooled and/or dehumidified which is also where outlet 108 and inlets 102 are placed during operation. In one embodiment, wireless temperature and humidity sensor 116 is a DX80N9X1S1H WIRELESS SERIAL FLEXPOWER SNSR mounting a M12FTH2Q SERIAL TEMP/RH SMART SENSOR. The system also includes a DX80G9M6S4P4M2M2 WIRELESS GATEWAY that operates as a receiver in vehicle 10 (not illustrated) and a DX85M6P6 MODBUS RTU SLAVE EXP I/O module connected between the wireless gateway and controller 60. These components are offered by BANNER ENGINEERING at http://www.bannerengineering.com/en-US/.

Engine 20 is coupled to fuel tank 28 and engine 20 includes radiator 26, intake 27 and exhaust conduit 29. In the illustrated embodiment, fuel tank 28 has a 90-gallon capacity and engine 20 includes an integrated fan (not illustrated) to force airflow across radiator 26. Radiator 26 and intake 27 are located in engine compartment 130. Exhaust conduit 29 is ported outside of vehicle 10. Engine 20 has a mechanical output 21 coupled to mechanical input 31 of generator 30. The coupling between mechanical output 21 and input 31 can be of any form known in the art. The illustrated embodiment uses a direct coupling. Generator 30 includes receptacles 32 and power output 34. Power output 34 powers compressors 40 and 50, blowers 106 and 122 and heaters 110 and 112, among other components.

Receptacles 32 can be located anywhere desired in, on or outside vehicle 10. In one embodiment, receptacles 32 include two duplex boxes mounted on the exterior of vehicle 10 and two runs of 2/0 cable that each have six outlets that can be deployed remotely from vehicle 10. The two runs of cable can be coupled to generator 30 via removable industrial connections. Circuit breakers (not illustrated) and voltage transformers (not illustrated) can be located between receptacles 32 and generator 30.

Compressors 40 and 50 are part of refrigeration cycle system 140 that includes condenser coils 42 and 52, expansion valve 44, evaporator coil 46, hot gas bypass (HGBP) 48 and HGBP valve 49. Condenser coils 42 and 52 are located in AC exhaust duct 120. AC exhaust duct 120 includes inlet 124, outlet 126 and blower 122. HGBP 48 delivers hot refrigerant vapor between expansion valve 44 and evaporator coil 46 when HGBP valve 49 is opened. One use of HGBP 48 is to increase the humidity removal capacity of evaporator coil 46 without excessively cooling the airflow in HVAC duct 100. In some embodiments, HGBP valve 49 can approximately infinitely vary the rate of hot gas flow. In other embodiments, HGBP valve 49 acts as an on/off valve.

In the embodiment illustrated in the FIGs., engine 20 is an oil cooled, 208 Volt, 3-phase DEUTZ 2011 diesel engine that includes oil access ports. The DEUTZ 2011 engine includes an internal oil pump system (not illustrated) that supplies sufficient pressure to circulate oil through radiator 24 and heat transfer fluid line 22. The DEUTZ 2011 engine also includes temperature springs and diaphragms that control the flow of oil out of the ports. In the illustrated embodiment, the springs and diaphragms are removed and replaced by control valve 23 operated by controller 60. However, in other embodiments the temperature springs and diaphragms could also be used to regulate oil flow to radiator 24 in addition to the use of control valve 23.

Other embodiments (that are not illustrated) can us other types of engines including a YANMAR 4TNV98T diesel engine. In an embodiment utilizing an YANMAR diesel engine, glycol is used as a heat transfer fluid in line 22 and radiator 24.

Controller 60 operates to control the function of engine 20, generator 30, compressors 40 and 50, control valve 23, blowers 106 and 122, heaters 110 and 112, and HGBP valve 49. Interface 62 provides a human interface to operate controller 60. In the illustrated embodiment, interface 62 comprises a touch-screen, buttons and switches. Particulars of controller 60 are described below.

In heating mode, system 150 operates to provide heating through a combination of radiator 24 and heaters 110 and 112. Controller 60 operates control valve 23 to permit the flow of the heat transfer fluid through radiator 24 and regulates power to heaters 110 and 112 based on feedback received from wireless temperature and humidity sensor 116 that is remotely located in the space being heated. In cooling and/or humidity control mode, controller 60 operates compressors 40 and 50 and HGBP valve 49 to regulate the temperature and humidity of the air passing through HVAC duct 100 based upon temperature and humidity readings from wireless temperature and humidity sensor 116 remotely located in the space being conditioned.

In the illustrated embodiment, engine 20 and generator 30 are configured as a 45 kW generator set. Refrigeration cycle system 140 is a 120,000 BTU system and heaters 110 and 112 are each 15 kW heaters. System 150 has a maximum heat output of approximately 40 kW utilizing radiator 24 and heaters 110 and 112. At 40 kW of heat output, the illustrated system 150 consumes approximately 3.5 gallons of diesel fuel each hour.

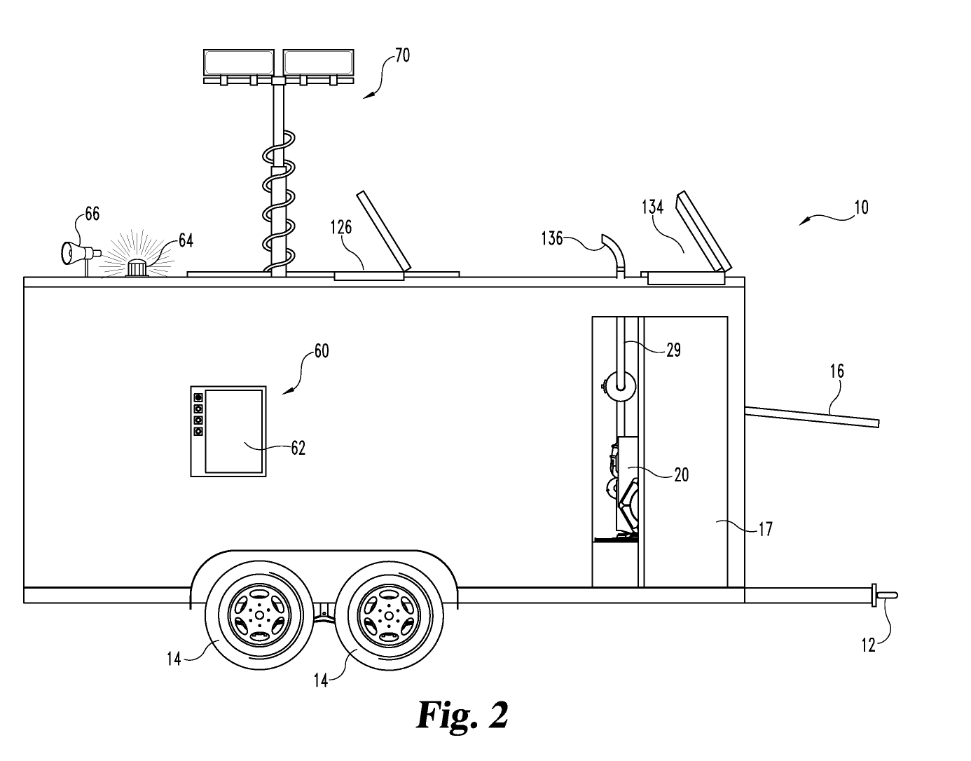

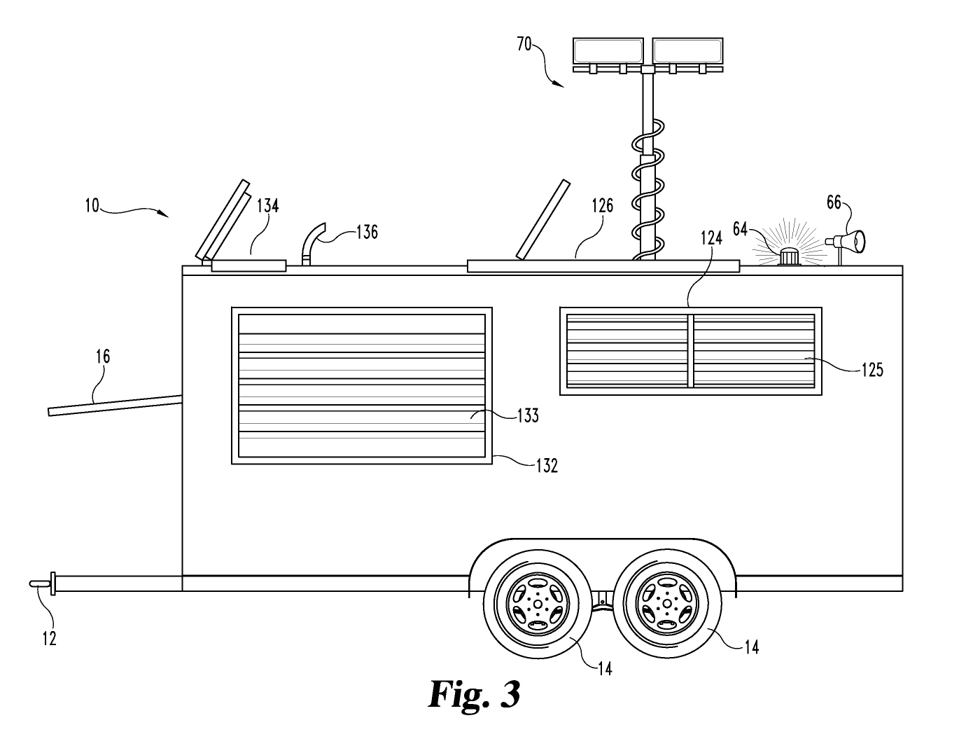

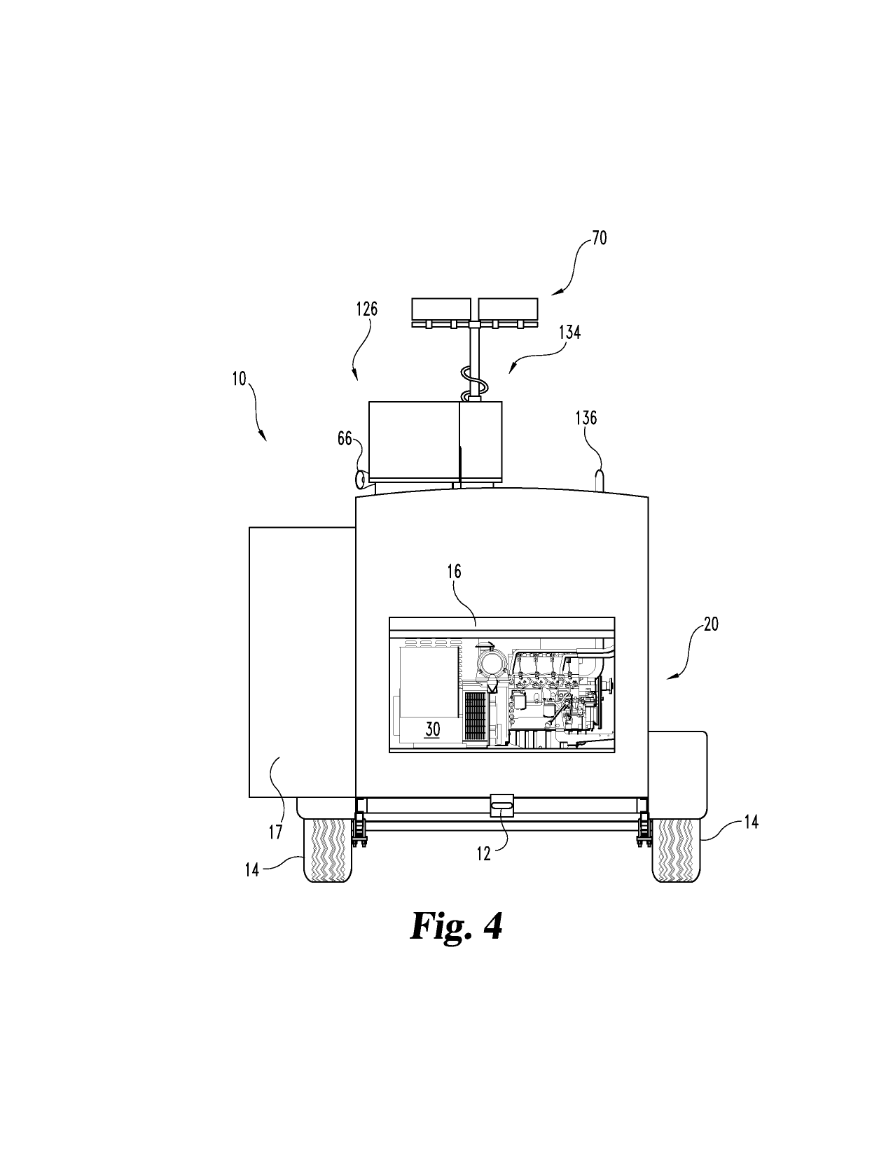

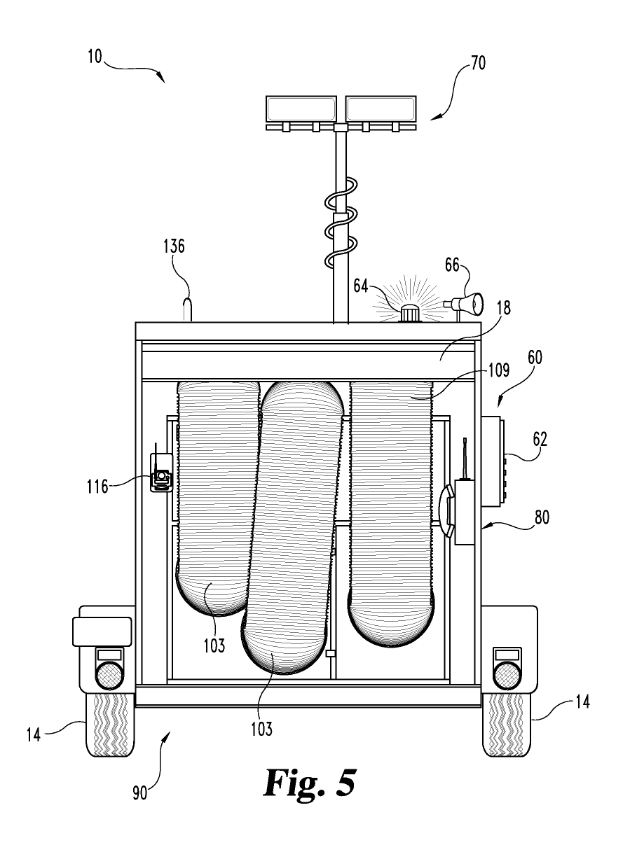

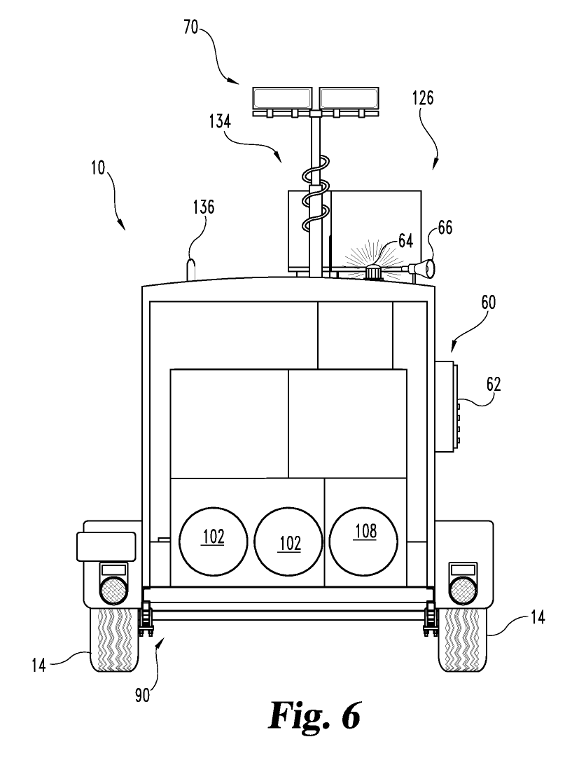

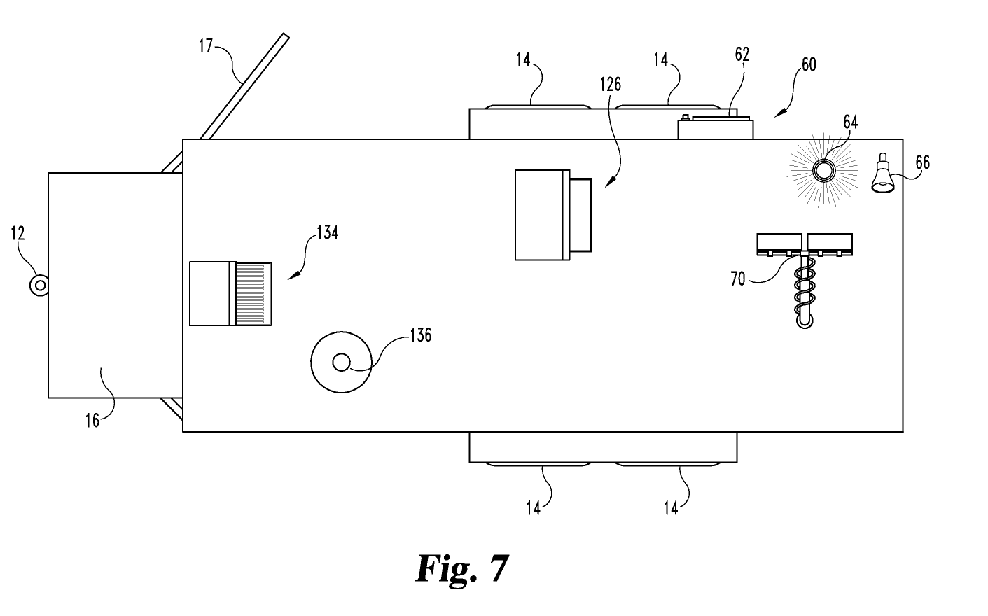

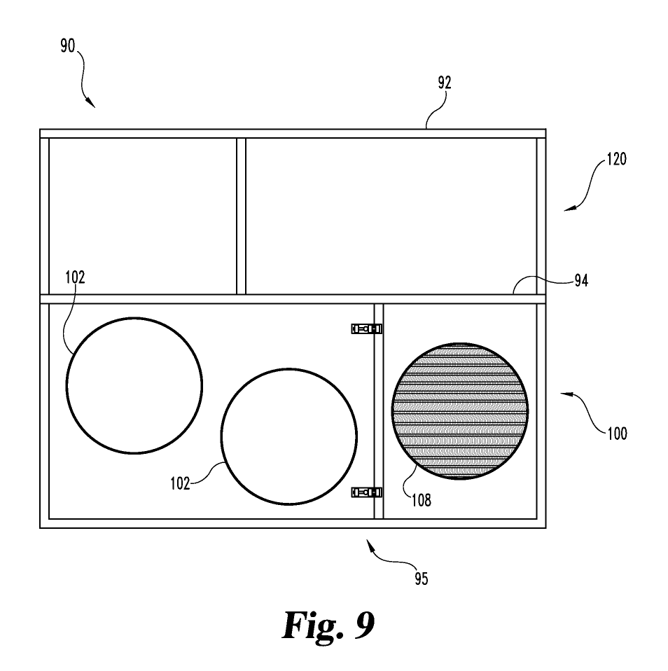

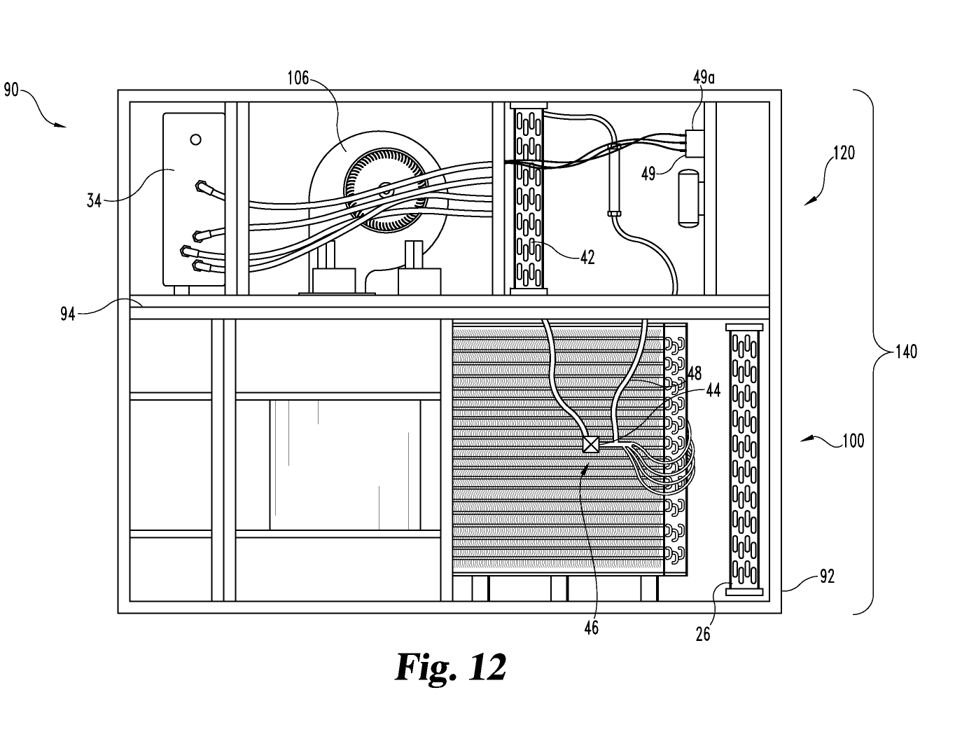

Referring now to FIG. 2 through FIG. 8, an embodiment of system 150 is illustrated and mounted on a trailer 10 (which serves as vehicle 10). Trailer 10 includes hitch 12, wheels 14, engine access panel 16 and 17 and rear door 18. Trailer 10 also includes outlet 126 and exhaust 134, muffler 136, inlet 124 and 132, light station 70, warning light 64, siren 66, controller 60 and control panel interface 62. Light station 70 is configured to be folded and stowed on the top of trailer 10 as shown in FIG. 7. Light station 70 can be elevated to the illustrated position of FIG. 2 and rotated and pitched to provide illumination in a desired direction. Muffler 136 is connected to exhaust conduit 29. Warning light 64 and siren 66 are operated by controller 60 to provide audio and visual warnings of important events such as low fuel. Trailer 10 holds many of the components of system 150; including engine 20, generator 30, and refrigeration cycle system 140, contained on HVAC unit 90 (as illustrated in FIG. 5 and described below with respect to FIGS. 9-13). In terms of the direction and orientation of vehicle 10, now trailer 10, the towing end is the front and the opposite end is the rear. The left and right sides are determined based on facing the trailer 10 from the towing end.

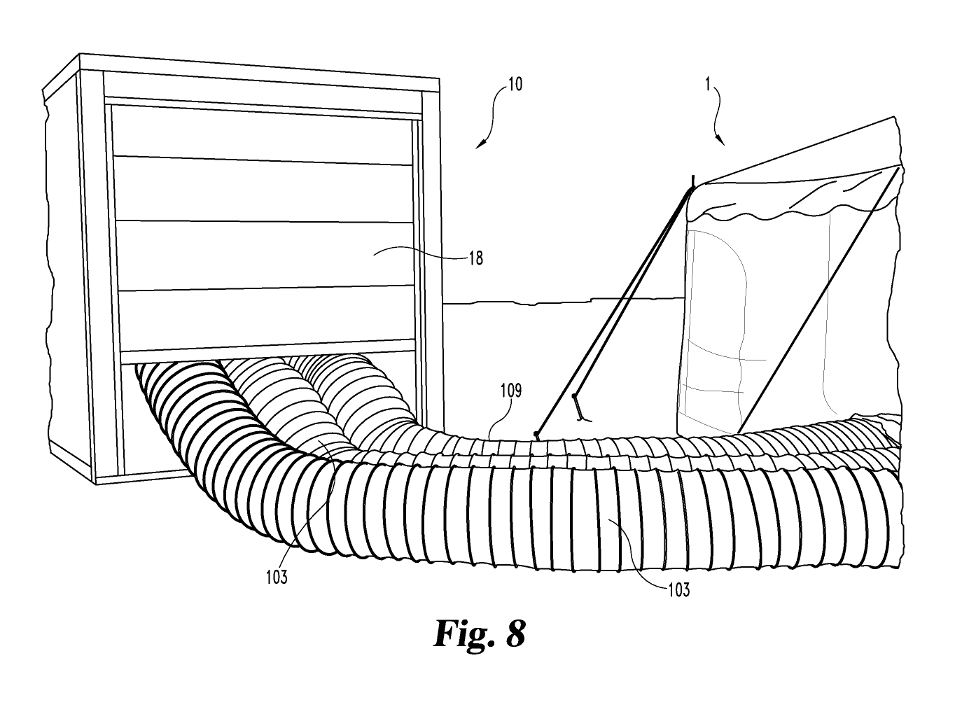

Referring to FIG. 8, trailer 10 is illustrated in use to supply heated or cooled air to space 1, which, as shown in FIG. 8, is a portable tent. Return hose 103 and supply hose 109 are flexible 18 inch ducts connecting inlets 102 and outlet 108 to space 1. In other embodiments, space 1 could be a building, trailer or any other at least partially enclosed space in which HVAC is desired.

Referring now to FIG. 9 through FIG. 13, HVAC unit 90 is illustrated. HVAC unit 90 is a self-contained palletized unit that includes refrigeration cycle system 140, HVAC duct 100 and AC exhaust duct 120 (also see FIG. 1).

HVAC unit 90 includes inlets 102, outlet 108, compressors 40 and 50, condenser coils 42 and 52, head pressure transducer 45, evaporator coil 46, drain 47, blowers 106 and 122, HGBP valve 49, HGBP solenoid 49a, expansion valve 44, filter rack 105, holding filters 104, and heaters 110 and 112. Drain 47 is located under evaporator coil 46 to collect and drain any condensed water.

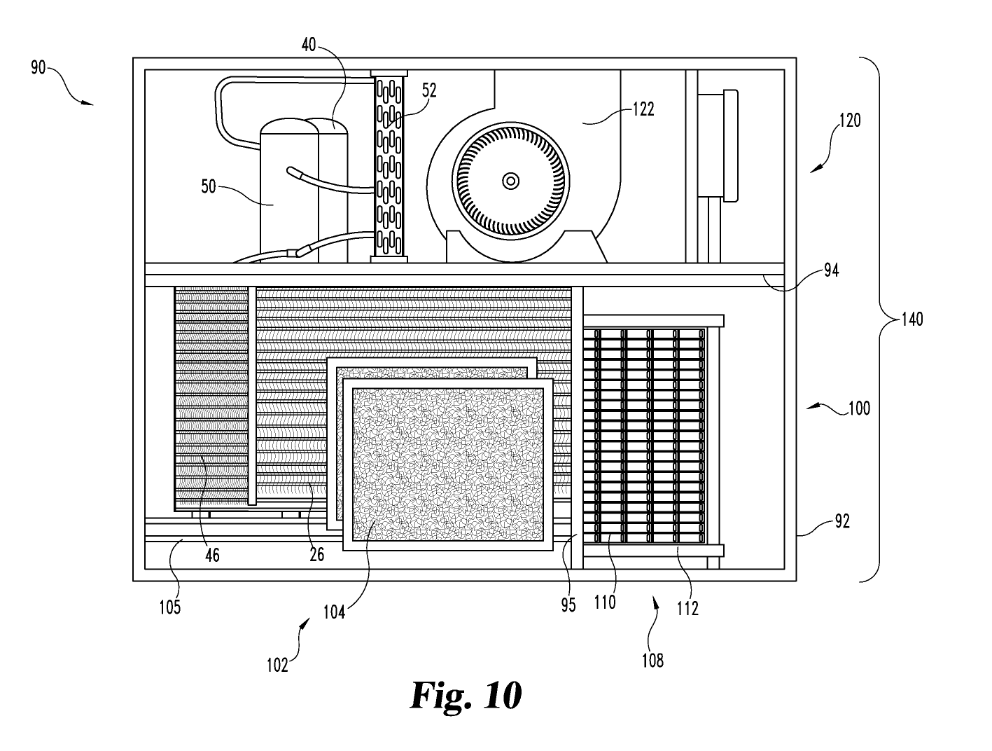

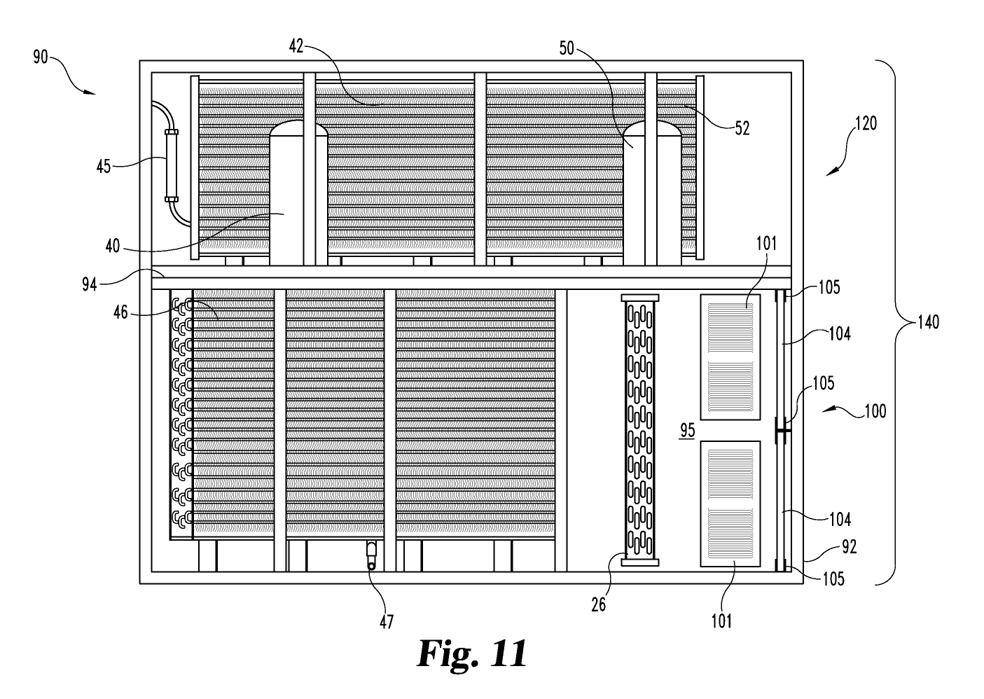

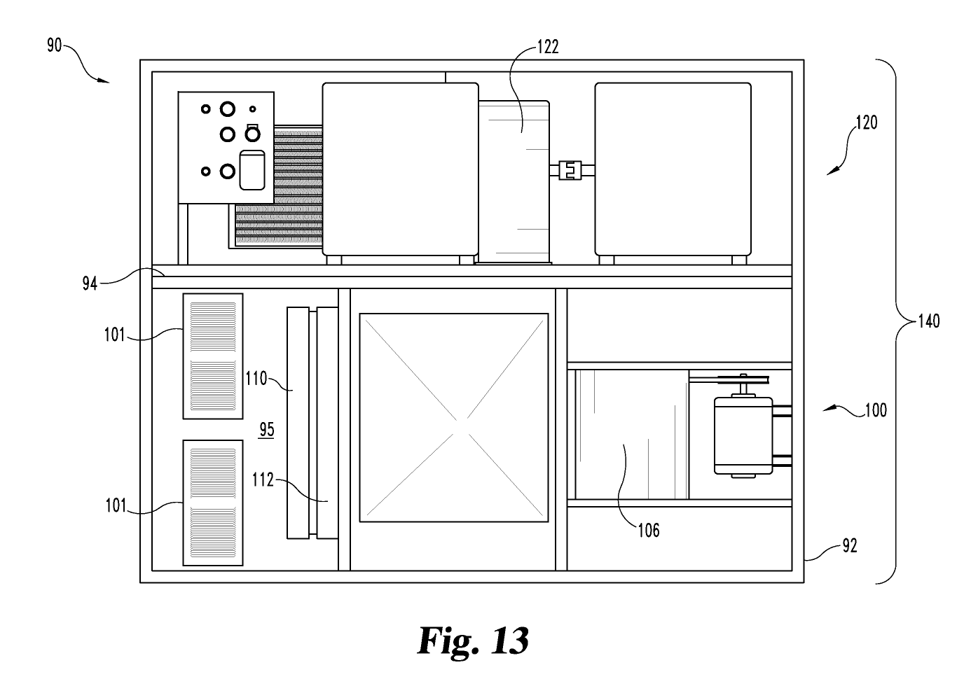

HVAC unit 90 is configured with HVAC duct 100 on the bottom portion and AC exhaust duct 120 on the top portion, HVAC duct 100 and AC exhaust duct 120 are separated from each other by bulkhead 94. HVAC unit 90 also comprises frame units 92 that define the periphery of the palletized unit. HVAC duct 100 and AC exhaust duct 120 are both defined by approximately “U” shaped air flow passages through HVAC unit 90. For example, flow divider 95, as shown in FIGS. 10, 11 and 13, defines and separates inlets 102 from outlets 108 (as shown in FIG. 9). As shown in FIGS. 11 and 13, bypass 101 can be defined by adjustable vents located in flow divider 95.

AC exhaust duct 120 is located above HVAC duct 100 so that compressors 40 and 50 and HGBP 48 are located above expansion valve 44. HVAC unit 90 is configured such that it can be inserted and removed from trailer 10 as a single unit, however, it should be understood that in other embodiments, HVAC unit 90 could be directly incorporated into trailer 10 or any other type of vehicle 10.

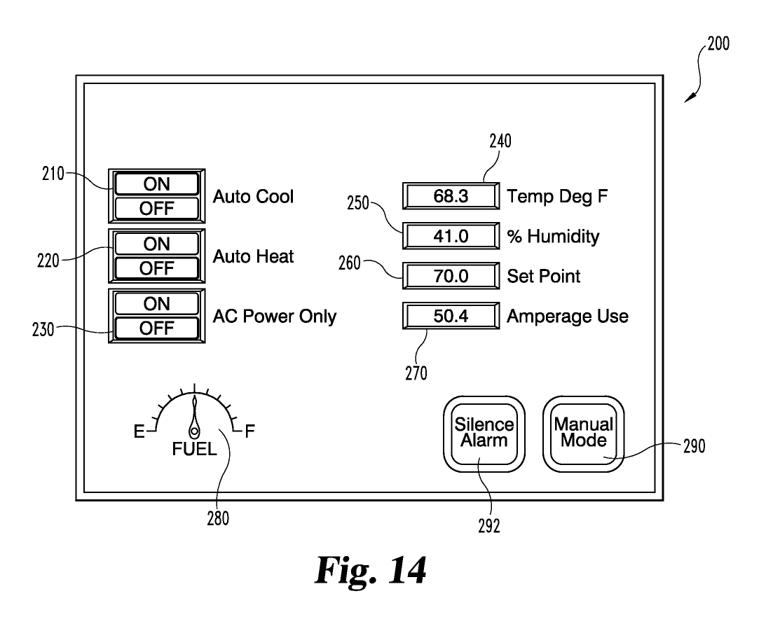

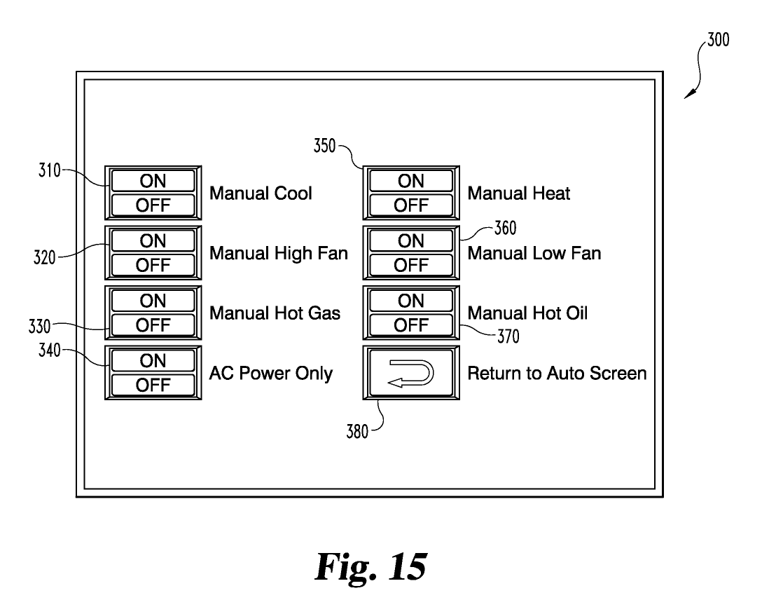

Referring now to FIGS. 14 and 15, one embodiment of interface 62 is illustrated as touch screens 200 and 300. FIG. 14 illustrates automatic control touch screen 200 while FIG. 15 illustrates a manual control touch screen 300. In this embodiment, controller 60 and interface 62 are an integrated PLC with a HMI user interface screen that provides a “one-touch” user interface with the entire system. The touch screens allow the user to select the desired result without any training in the operation of the individual components that make up system 150. Integrated controller 60 operates the system to provide the desired result selected by the user via interface 62. For example, when system 150 is set up with return hose 103, supply hose 109 and wireless temperature and humidity sensor 116 positioned in an enclosed space such as a tent, selection of the desired air conditioning or heating option on the touch screens described below operate system 150 to heat or cool the air in the tent to the desired conditions regardless of environmental conditions (within the operating capacity of system 150).

Automatic control touch screen 200 includes the following ON/OFF touch screen control inputs: auto cool 210, auto heat 220, AC power only 230, each of which provide ON/OFF toggling with visible feedback of the selected mode. Automatic control touch screen 200 also includes temperature readout 240, humidity readout 250, temperature set point 260, amperage readout 270, fuel gauge readout 280, manual mode select 290 and alarm silence 292. Temperature readout 240 and humidity readout 250 display measurements from wireless temperature and humidity sensor 116. Amperage readout 270 indicates the current amperage load on generator 30. Fuel gauge 280 indicates the fuel level in fuel tank 28 determined from a fuel level sensor (not illustrated). The actual numbers shown on readouts 240, 250, 260 and 270 are for example only. The same is true for the fuel level, the actual reading is for example only. Temperature set point 260 displays the current programmed set point. Selecting temperature set point 260 on touch screen 200 brings up a keypad on the touch screen that the user can use to input a desired temperature set point. Temperature set point 260 is utilized with both the auto cool and auto heat control schemes. Selecting auto cool 210 activates the auto cool control scheme and deactivates both the auto heat and AC power only control schemes. Selecting auto heat 220 activates the auto heat control schemes and deactivates both the auto cool and AC power only control schemes. Selecting AC power only 230 activates the AC power only control scheme and deactivates both the auto cool and auto heat control schemes. Selecting manual mode select 290 changes the active touch screen to manual control touch screen 300 as described below.

When the auto cool control scheme is activated, controller 60 automatically deactivates the auto heat and AC power only control schemes. Controller 60 then compares the measured temperature with temperature set point. If the measured temperature is more than 3° F. hotter than the temperature set point then compressor 40 and possibly compressor 50 are activated by controller 60. Controller 60 also compares the humidity measured by wireless temperature and humidity sensor 116 with a programmed set point of 40% humidity plus or minus 10%. When the humidity measured exceeds 50%, controller 60 activates solenoid 49a to open hot gas bypass valve 49 and when the measured humidity is less than 30% then solenoid 49a is deactivated to close hot gas bypass valve 49. Selection of auto cool 210 also activates blowers 106 and 122. The choice of using either condenser 40 or condensers 40 and 50 is made by a standard refrigeration control algorithm known to those skilled in the art. Under the auto control scheme, engine 20 is cooled by radiator 26.

In other embodiments where HGBP valve 49 is approximately infinitely variable, controller 60 can vary the setting of HGBP valve 49 to control the humidity within narrower control parameters as is known in the art. While the illustrated embodiment does not permit operator modification of the humidity set point, this option could be added to interface 62 by adding a control input set point for humidity, similar to temperature set point 260.

Engaging the auto heat control scheme initially engages blower 106 and powers heater 110. After running for approximately four minutes, controller 60 then opens control valve 23 to permit the flow of engine heat transfer fluid through radiator 24. Controller 60 then operates heaters 110 and 112 by comparing the temperature measured by sensor 116 with the programmed set point to be controlled within plus or minus 3° F. After the four-minute delay, control valve 23 remains open as long as the auto heat control scheme is selected.

Engaging the AC power only control scheme starts engine 20 and controls power output from engine 20 to match the demand from generator 30. In this mode, blowers 106 and 122 are disengaged. Control valve 23 and HGBP valve 49 are closed and compressors 40 and 50 are off as well as heaters 110 and 112. In this mode, engine 20 is cooled by radiator 26.

Referring to FIG. 15 and manual control touch screen 300, this screen includes the following ON/OFF touch screen control inputs: manual cool selection 310, manual high fan 320, manual hot gas 330, AC power only 340, manual heat 350, manual low fan 360, and manual hot oil 370. Also included is auto control screen selection 380. Selectors 310, 320, 330, 340, 350, 360 and 370 each have ON/OFF toggle displays providing feedback of the current operating mode. Selection of manual cool 310 disengages manual heat 350 and AC power only 340 and manual hot oil 370 and activates compressors 40 and 50. Selection of manual cool 310 also requires a selection of either manual high fan 320 or manual low fan 360 which are mutually exclusive wherein selection of one automatically deselects the other. When manual cool 310 is selected, manual hot gas 330 may optionally be activated which opens HGBP valve 49.

Selection of AC power only 340 engages engine 20 and disengages compressors 40 and 50 and heaters 110 and 112. Selection of manual heat 350 activates heaters 110 and 112 and also requires selection of either manual high fan 320 or manual low fan 360. Selection of manual heat 350 also deactivates any previous activation of manual cool 310 or AC power only 340. Selection of manual hot oil 370 opens control valve 23. In some embodiments an approximate four minute delay is incorporated between the selection of manual hot oil 370 and the opening of control valve 23. In other embodiments, there is no delay between the selection of manual hot oil 370 and the opening of control valve 23.

As used herein, “above” and “top” the refer to conventional use of such terms as illustrated in the drawings with the top of each page being “above” the bottom, with trailer 10 positioned with wheels 14 on a level ground surface and hitch 12 connected to a motorized vehicle at the approximate relative height illustrated in the drawings. Describing a first component as being positioned above a second component indicates that the first component is further from the ground surface than the second component but does not necessary require that the second component is between the first component and the ground surface.

While the disclosure has been illustrated and described in detail in the drawings and foregoing description, the same is to be considered as illustrative and not restrictive in character, it being understood that only the preferred embodiments have been shown and described and that all changes and modifications that come within the spirit of the disclosure are desired to be protected.

1. A system comprising:
a vehicle;
an electrical generator system comprising an engine and a generator;
a ventilation system comprising an HVAC duct and supply and return ducts constructed and arranged to be located in a space remote from said vehicle, wherein said supply and return ducts are operatively coupled to said HVAC duct and wherein said HVAC duct comprises an inlet and an outlet;
a radiator located in said HVAC duct constructed and arranged to circulate heat transfer fluid from said engine;
a refrigeration cycle system comprising a compressor, an evaporator coil, an expansion valve and a condenser coil, wherein said evaporator coil is located in said HVAC duct and said compressor is powered by said generator;
a heater located in said HVAC duct, wherein said heater is powered by said generator; and
a blower in said HVAC duct constructed and arranged to circulate air from said return duct, through said HVAC duct and then through said supply duct;
wherein said electrical generator system, said HVAC duct and said refrigeration cycle system are received by said vehicle.

2. The system of claim 1, wherein said radiator is positioned proximate to said HVAC duct inlet and said heater is positioned distally from said HVAC duct inlet.

3. The system of claim 1, wherein said refrigeration cycle system further comprises a hot gas bypass extending between the exit of said compressor and the exit of said expansion valve.

4. The system of claim 3, wherein said refrigeration cycle system further comprises an AC exhaust duct containing said condenser coil and wherein said AC exhaust duct is arranged above said HVAC duct when said vehicle is approximately level.

5. The system of claim 4, wherein said compressor is positioned approximately above said evaporator coil in said vehicle when said vehicle is approximately level.

6. The system of claim 1, further comprising:
a control valve constructed and arranged to control the circulation of heat transfer fluid from said engine to said radiator; and
a control system constructed and arranged to control the operation of said control valve, wherein said control system delays operating said control valve to circulate heat transfer fluid through said radiator for approximately four minutes after said blower and said heater are turned on.

7. The system of claim 1, further comprising a bypass constructed and arranged to transfer a portion of the air circulated by said blower from said HVAC duct outlet directly to said HVAC duct inlet without passing through the space.

8. The system of claim 7, wherein said radiator is located proximate to said HVAC duct inlet and said heater is located distally from said HVAC duct inlet.

9. The system of claim 1, wherein said refrigeration cycle system further comprises an AC exhaust duct containing said condenser coil and wherein said AC exhaust duct is arranged above said HVAC duct when said vehicle is approximately level.

10. A system comprising:
a vehicle;
an electrical generator system comprising an engine and a generator;
a ventilation system comprising an HVAC duct and supply and return ducts constructed and arranged to be located in a space remote from said vehicle, wherein said supply and return ducts are operatively coupled to said HVAC duct and wherein said HVAC duct comprises an inlet and an outlet;
a refrigeration cycle system comprising a compressor, an evaporator coil, an expansion valve and a condenser coil, wherein said evaporator coil is located in said HVAC duct and said compressor is powered by said generator;
a heater located in said HVAC duct, wherein said heater is powered by said generator;
a blower in said HVAC duct constructed and arranged to circulate air from said return duct, through said HVAC duct and then through said supply duct; and
a bypass constructed and arranged to transfer a portion of the air circulated by said blower from said HVAC duct outlet directly to said HVAC duct inlet without passing through the space;
wherein said electrical generator system, said HVAC duct and said refrigeration cycle system are received by said vehicle.

11. The system of claim 10, further comprising:
a radiator located in said HVAC duct constructed and arranged to circulate heat transfer fluid from said engine;
a control valve constructed and arranged to control the circulation of heat transfer fluid from said engine to said radiator; and
a control system constructed and arranged to control the operation of said control valve, wherein said control system delay operating said control valve to circulate heat transfer fluid through said radiator for approximately four minutes after said blower and said heater are turned on.

12. The system of claim 11, further comprising a bypass constructed and arranged to transfer a portion of the air circulated by said blower from said HVAC duct outlet directly to said HVAC duct inlet without passing through the space.

13. The system of claim 12, wherein said radiator is located proximate to said HVAC duct inlet and said heater is located distally from said HVAC duct inlet.

14. The system of claim 10, wherein said refrigeration cycle system further comprises an AC exhaust duct containing said condenser coil and wherein said AC exhaust duct is arranged above said HVAC duct when said vehicle is approximately level.

15. A system comprising:
an electrical generator system comprising an engine and a generator;
a ventilation system comprising an HVAC duct and supply and return ducts, wherein said supply and return ducts are operatively coupled to said HVAC duct and wherein said HVAC duct comprises an inlet and an outlet;
a radiator located in said HVAC duct constructed and arranged to circulate heat transfer fluid from said engine;
a refrigeration cycle system comprising a compressor, an evaporator coil, an expansion valve and a condenser coil, wherein said evaporator coil is located in said HVAC duct and said compressor is powered by said generator;
a heater located in said HVAC duct, wherein said heater is powered by said generator; and
a blower in said HVAC duct constructed and arranged to circulate air from said return duct, through said HVAC duct and then through said supply duct;
wherein said electrical generator system, said HVAC duct and said refrigeration cycle system are constructed and arranged to be mounted in a vehicle.

16. The system of claim 15, wherein said radiator is positioned proximate to said HVAC duct inlet and said heater is positioned distally from said HVAC duct inlet.

17. The system of claim 15, wherein said refrigeration cycle system further comprises a hot gas bypass extending between the exit of said compressor and the exit of said expansion valve.

18. The system of claim 15, wherein said refrigeration cycle system further comprises an AC exhaust duct containing said condenser coil and wherein said AC exhaust duct is arranged above said HVAC duct when said vehicle is approximately level.

19. The system of claim 15, further comprising:
a control valve constructed and arranged to control the circulation of heat transfer fluid from said engine to said radiator; and
a control system constructed and arranged to control the operation of said control valve, wherein said control system delays operating said control valve to circulate heat transfer fluid through said radiator for approximately four minutes after said blower and said heater are turned on.

20. The system of claim 15, further comprising a bypass constructed and arranged to transfer a portion of the air circulated by said blower from said HVAC duct outlet directly to said HVAC duct inlet without passing through the space.
